(19) United States
(12) Patent Application Publication
(10) Pub. No.: US 2011/0225480 A1
(43) Pub. Date: Sep. 15, 2011

(54) URL PROXY METHOD AND APPARATUS

(75) Inventor: Adam GOLDBAND, Antioch, CA (US)

(73) Assignee: CBS Interactive, San Francisco, CA (US)

(21) Appl. No.: 12/759,238

(22) Filed: Apr. 13, 2010

Related U.S. Application Data
(60) Provisional application No. 61/312,162, filed on Mar. 9, 2010.

(51) Int. Cl. G06F 17/00

(52) U.S. Cl. 715/205; 715/234

(57) ABSTRACT

Embodiments of the present invention relate to a method and system in which a repository of rules is applied to HTML code to modify the HTML code as it is served to correct/replace elements in the HTML code. For example, the links can be changed to retain a cobranded site, accommodate a resource constrained device, and accommodate a user's subscription or the like.

### CLAIM OF BENEFIT AND INCORPORATION BY REFERENCE

This application claims priority to previously-filed U.S. Provisional Patent Application No. 61/312,162 to GOLDBAND, filed Mar. 9, 2010, entitled “URL PROXY METHOD AND APPARATUS”, the entire disclosure of which is incorporated by reference herein.

### TECHNICAL FIELD

The present disclosure relates to a method, system, and computer-readable media for automatically modifying a page stored in computer memory as multiple page elements.

### BACKGROUND OF THE INVENTION

Various content, such as web pages, is served over the internet to various devices and for various purposes. Accordingly, it is often desirable to present the content in different manners under different circumstances. One way to do this is to have a different version of the content for each foreseeable combination of users, devices, and purposes. This requires a great deal of resources and is often unmanageable.

As an example, the concept of co-branding has evolved to include online co-branding of web sites and/or web content. One way of establishing an online co-brand is if the owner of a web site offers content to a partner website such that the web content appears to be part of the owner's web site, as well as the partner's web site. This type of online alliance can have many advantages. In a specific example, a company that is selling flat screen displays offers a partner web site to also sell their flat screen displays, and receive a commission or percentage of the sale price when the flat screen display devices are purchased directly from the partner's site, or when viewing the partner's web site results in the purchase of the flat panel display. This alliance increases the exposure of the flat screen display device by recruiting the partner to help the company sell their product, and can generates revenue for the partner. Also, co branding allows the partner web site to appear to have the content of the provider web site.

A different implementation can be the creation a single web site that has more than one look. A web site that sells both child-related products, and products that are geared specifically towards adults, for example, will benefit by having a format that appeals to children when the child-related products are being viewed, and a different format and/or layout that entices adults while viewing the products geared toward adults. This concept of co-branding can also be extended to created different looks for the same web site, based upon the type of computing device that the user access the web site through, e.g., a desk top personal computer, a laptop, Blackberry™, or iPhone™, etc.

There are obviously a multitude of avenues by which online experiences can be achieved, including an owner creating multiple websites, or allowing users to access your content via a pop-up window. However, co-branding and other user experience flexibility requires complex manipulation of the web content to create a seamless experience and proper navigation. For example, the user experience can be flawed by an incorrect URL being included on a content page, that when clicked will direct a user out of the co-brand experience.

### SUMMARY OF THE INVENTION

Embodiments disclosed herein relate to a method for modifying a page stored in computer memory as multiple page elements, the method including receiving a request from a user for a page stored in a computer memory, in response to the request, applying a set of rules to page elements of the page, modifying the code corresponding to the page elements based on the rules, and serving the page with the modified code to the user.

The embodiments of the present invention also relate to a system for modifying a page stored in computer memory as multiple page elements including receiving a request from a user for a page stored in a computer memory, a rules store for applying a set of rules to page elements of the page in response to the request, a modification module for modifying the code corresponding to the page elements based on the rules, and a web layer for serving the page with the modified code to the user.

Furthermore, the embodiments of the present invention relate to a computer-readable storage media having computer executable instructions stored thereon which cause a computer system to carry out a method when executed, the method including receiving a request from a user for a page stored in a computer memory, in response to the request, applying a set of rules to page elements of the page, modifying the code corresponding to the page elements based on the rules, and serving the page with the modified code to the user.

Additionally, the embodiments of the present invention relate to a method for modifying a page stored in computer memory as multiple page elements wherein said modifying step comprises making links in the page correspond to a standard ontology, wherein said modifying step comprises making links in the page correspond to a branded user experience, wherein said modifying step comprises making page elements correspond to resources of a user device, and wherein said modifying step comprises making links in the page correspond to content for which a user has subscribed.

The embodiments of the present invention further relate to a system for modifying a page stored in computer memory as multiple page elements including receiving a request form a user for a page stored in a computer memory wherein said modification module comprises making links in the page correspond to a standard ontology, wherein said modifying step makes links in the page correspond to a branded user experience, wherein said modification module makes page elements correspond to resources of a user device, and wherein said modification module makes links in the page correspond to content for which a user has subscribed.

Furthermore, the embodiments of the present invention relate to a computer-readable storage media having computer executable instructions stored thereon which cause a computer system to carry out a method when executed, the method including wherein said modifying step comprises making links in the page correspond to a standard ontology, wherein said modifying step comprises making links in the page correspond to a branded user experience, wherein said modifying step comprises making page elements correspond to resources of a user device, and wherein said modifying step comprises making links in the page correspond to content for which a user has subscribed.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

FIG. 1 is a functional block diagram of a computer architecture in accordance with an embodiment;

FIG. 2 is a structural block diagram of a computer architecture in accordance with an embodiment including a rules database;

FIG. 3 is a schematic representation of the rules database;

FIG. 4 is a flowchart illustrating an embodiment of a method for modifying a page stored in computer memory as multiple page elements according to the present invention; and

FIG. 5 is a diagrammatic representation of a computing device in accordance with the present invention.

### DETAILED DESCRIPTION OF THE PREFERRED EMBODIMENT

For a general understanding of the features of the present invention, reference is made to the drawings, wherein like reference numerals have been used throughout to identify identical or similar elements. While the present invention is described in terms of an illustrative embodiment or embodiments, it will be understood that the invention is adaptable to a variety of HTML code modifications, such that the present invention is not necessarily limited to the particular embodiment or embodiments shown and described herein. To the contrary, the following description is intended to cover all alternatives, modifications, and equivalents, as may be included within the spirit and scope of the invention. Specially, it will be understood that the instant invention applies to all various types of rules for modifying HTML code and URLs listed on a content page, and it is not intended to be limited by the manner in which the rules are applied.

One embodiment of the present disclosure fixes incorrect URLs located on a requested content page, prior to the page's delivery to the user. In another embodiment, the present system can also be used to correct HTML code of a requested page to thereby retain a cobranded site, accommodate a resource constrained device (e.g., a PDA, iPhone™, a BlackBerry™, etc.), accommodate a user's subscription, or the like. The present invention can be used on any Website, and the method, system, and computer-readable medium for fixing URLs described herein are extremely valuable from a search engine optimization (SEO) standpoint, in that the incorrect URLs can be fixed to include keywords that are desirable by search engines.

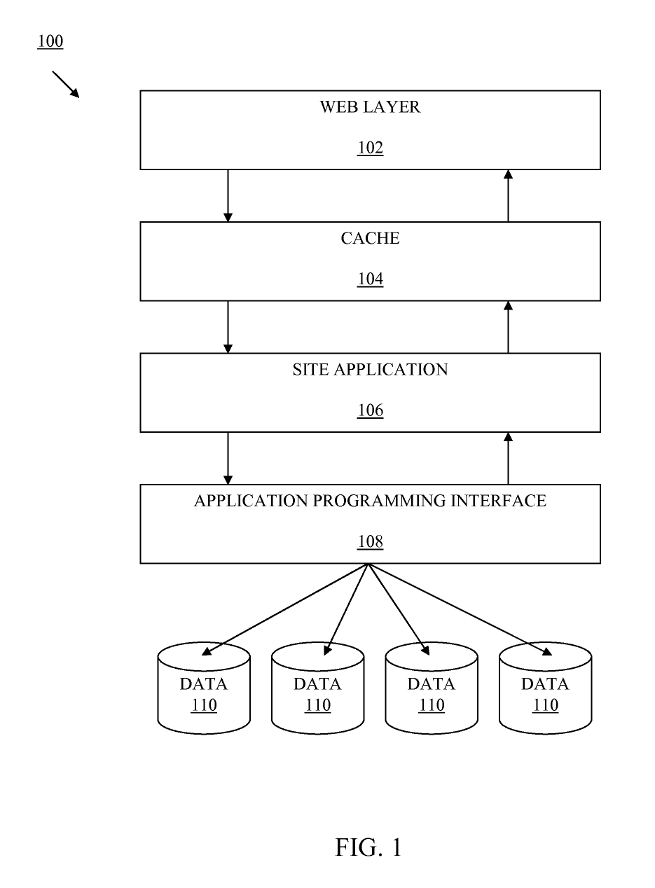

A functional illustration of the computer architecture of a preferred embodiment of the present invention is depicted by FIG. 1. System architecture 100 includes a web layer 102, a cache 104, a site application 106, an application programming interface 108, and a plurality of data stores 110. However, as is understood, the system architecture may vary from the illustrated architecture. For example, web layer 102 may directly access data stores 110, the site application 106 may directly access data stores 110, system architecture 100 may not include cache 104, etc., as will be appreciated by those skilled in the art. Web layer 102 is configured to receive user requests to access content through a web browser and return content that is responsive to the user request. Web layer 102 communicates the user requests to cache 104. Cache 104 is configured to temporarily store content that is accessed frequently by web layer 102 and can be rapidly accessed by web layer 102. In one embodiment, cache 104 may be a caching proxy server. Cache 104 communicates the user requests to site application 106.

Site application 106 is configured to update cache 104 and to process user requests received from web layer 102. Site application 106 may identify that the user request is for a page that includes data from multiple sources. Site application 106 can then convert the page request into a request for content from multiple sources and transmits these requests to application programming interface 108. Application programming interface 108 is configured to simultaneously access data from the plurality of data stores 110 to collect the data responsive to the plurality of requests from site application 106. The plurality of data stores 110 may include, for example, catalogue data about different product types (e.g., product specifications, pricing, images, etc.), content components, and the like. It will be appreciated that in alternative embodiments only one data store 110 may be provided to store the data.

The data in data stores 110 is provided to application programming interface 108, which provides the content to site application 106. Site application 106 updates cache 104 and delivers the cached content in combination with the accessed content to web layer 110, which delivers browsable content to the user, such as through a product landing page.

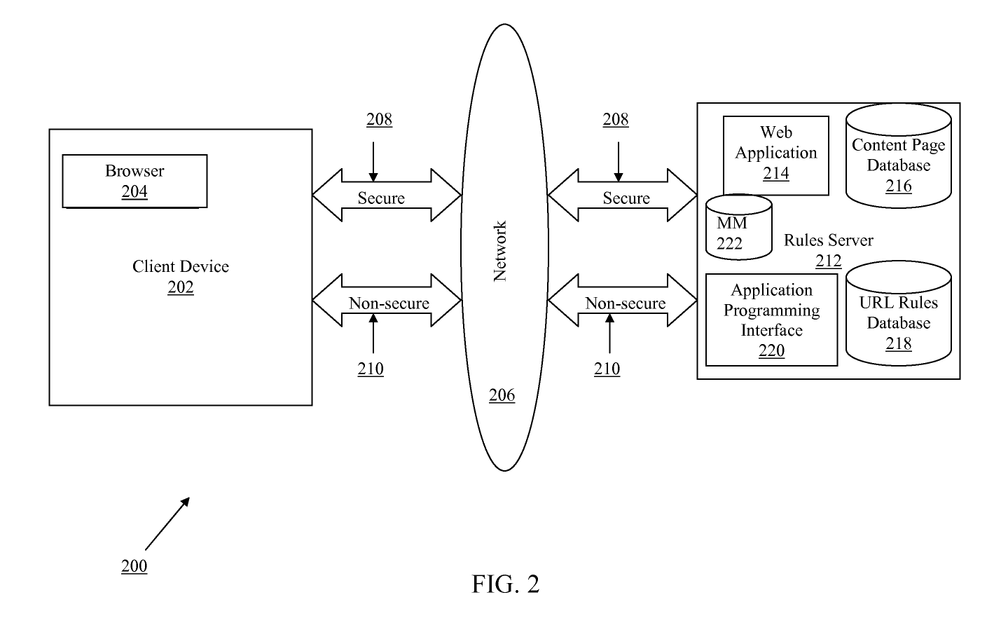

A structural illustration of a preferred embodiment of a computer architecture of the present invention can be seen in FIG. 2. Customizable uniform resource locator (URL) system 200 includes client computer 202, which executes browser application 204 that supports the HTTP protocol, or other appropriate protocols. Client computer 202 is connected, typically through an ISP (Internet Service Provider), to Network 206 serving as a communication channel. For example, client computer 202 can be coupled to the ISP through a broadband connection such as ISDN (Integrated Services Digital Network), a cable modem, or a DSL (Digital Subscriber Line) connection. Rules server 212 is also coupled to the Internet 206 in a known manner. Rules server 212 executes, for example, a web application 214, known as an HTTP server application, stored in a memory device. For example, public domain web server software applications from NCSA or APACHE can be used.

In the preferred embodiment, both of the client computer 202 and the rules server 212 can be capable of communicating using a secure connection protocol, such as SSL or S-HTTP. For clarity, non-secure connections 210 and secure connections 208 are illustrated separately. However, typically, these connections will be effected over the same physical connection or communication channel, such as Internet. Further, rules server 212 can have many content pages stored in memory devices thereof, such as HTML format and/or other formats. Rules server 212 also includes content page database 216 stored in the memory device thereof as described in detail below. Moreover, content page database 216 stores content record data for at least one type of content. Content record data may include a product a blog post, a user comment, a review, an article, a whitepaper, news, and a company, just to name a few. Content record data may also include a product's specifications such as price, type, dimensions, weight, material, color, display type, sound output, accessories, operating system, and manufacturer, among other things. Client computer 202 can request a display of a content page from rule server 212 by issuing a URL request through the Internet to rules server 212. For example, a user of client computer 202, i.e., a searcher, can enter a product query, including at least one product term(s) and/or attribute, into a form page displayed by browser 204, or merely clicking a URL link for an item and/or product on a page. The browser interface can be populated with suggested product landing pages that are based on the product search criteria from content page database 216, and the user can then select a product page for viewing.

Rules server 212 executes, for example, an application programming interface (API) 120 that requests content pages, once the web application 214 has received a request for a content page. Rules server 212 also includes a URL rules database 218 that stores rules, which are applied to a catalog of content that is embedded in the structure of a URL. The system is able to parse the HTML of a requested page, and then fix incorrect URLs on the page prior to the page being delivered to the user. Rules stored in rules database 218 can also be applied to HTML code of the page, such that before the page is served, incorrect elements in the HTML code are fixed. Modification module (MM) 222 then modifies the incorrect HTML code (e.g., incorrect URL) prior to the page being sent to the user, based upon a rule.

For example, the URL links can be corrected to retain a cobranded site, accommodate a resource constrained device (e.g., a PDA, iPhone™, or a BlackBerry™), accommodate a user's subscription, or the like. In addition, the rules may be applied to a particular HTML tag to correct images or videos that are included on the content page, before delivering the page to the user.

In another example, a rule can be applied to fix, for example, an incorrect URL that was included on a content page by an editor of that page, a web site's internal editor or a blogger. If a rule exists to fix the incorrect URL link, then the system replaces the incorrect URL on the requested content page, such that the correct URL automatically appears on the content page.

Although web application 214, content page database 216, rules database 218 and modifications module 222 are all shown a components of rules server 212, it will be understood by those of ordinary skill in the art, that the components can be included in different layers of a servers connected to one another.

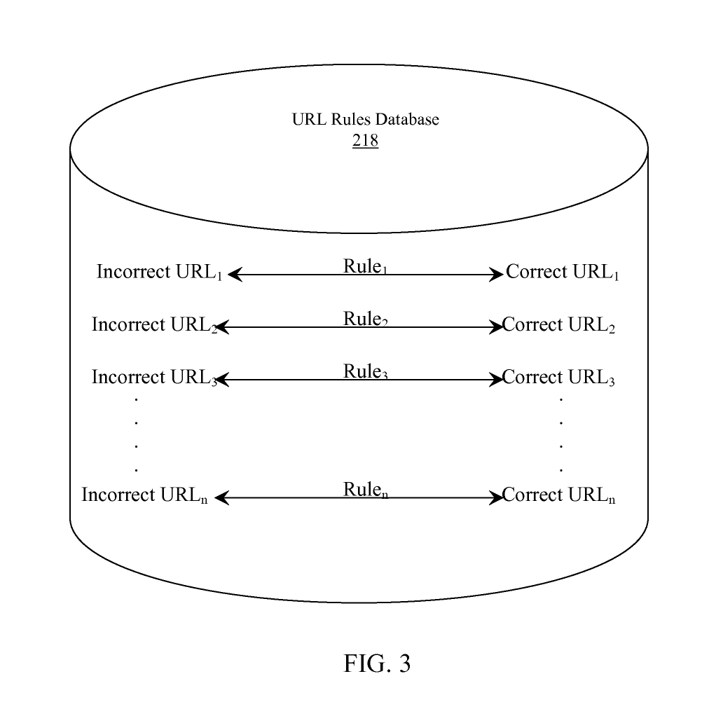

A more detailed illustration of the rules database 218 can be seen in FIG. 3. Specifically, each rule (e.g., Rule₁, Rule₂, Rule₃ through Ruleₙ) determines how to fix an incorrect URL (e.g., Incorrect URL₁, Incorrect URL₂, Incorrect URL₃ through Incorrect URLₙ) so that a correct URL (e.g., Correct URL₁, Correct URL₂, Correct URL₃ through Correct URLₙ) is replaced on the content page prior to its receipt by the user.

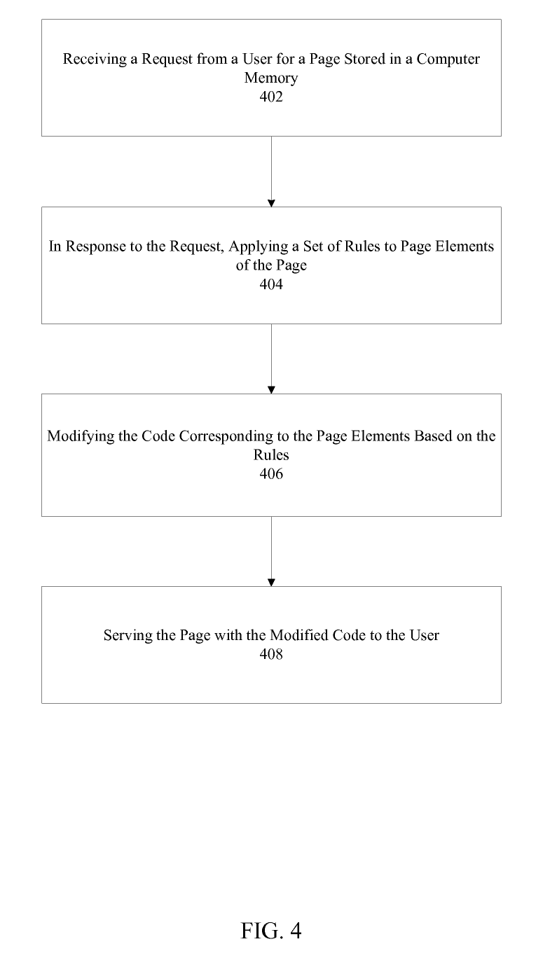

FIG. 4 illustrates a flowchart for providing real-time communication via text between multiple user devices in another embodiment of the present invention, which will now be described in further detail. In step 402, a request from a user for a page stored in a computer memory is received. In response to the request, in step 404, a set of rules is applied to page elements of the page. Then, the code corresponding to the page elements based on the rules is modified in step 406, and the page with the modified code is then served to the user in step 408.

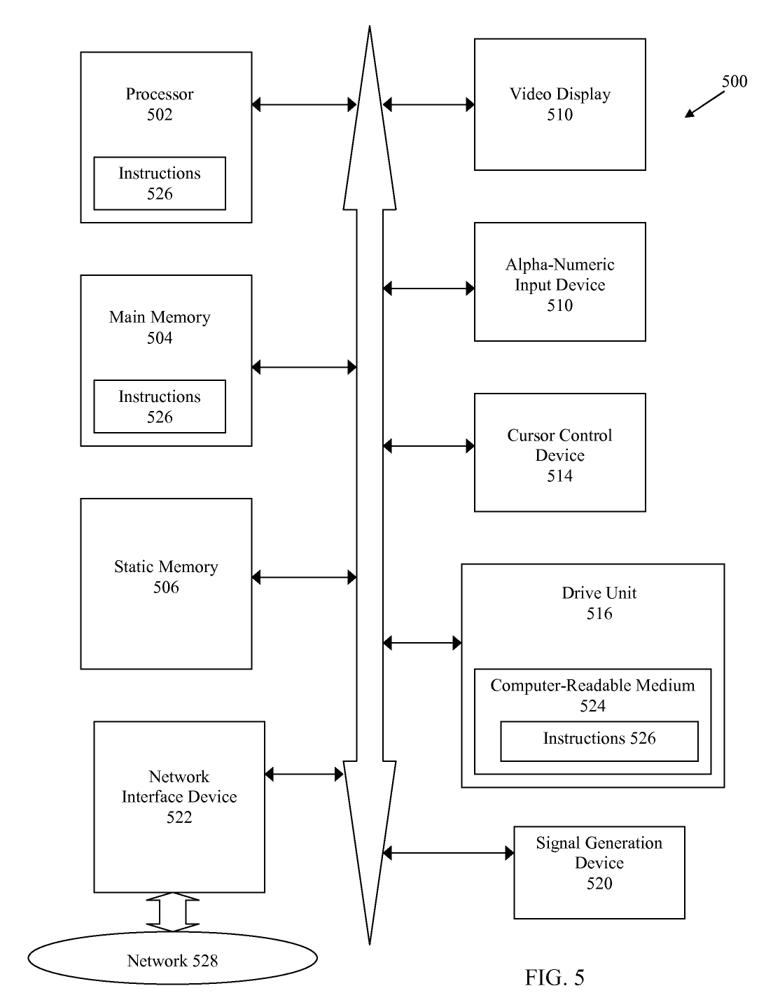

FIG. 5 depicts a diagrammatic representation of a machine in the exemplary form of a computer system 500 within which a set of instructions, for causing the machine to perform any one or more of the methodologies discussed herein, may be executed. In various embodiments, the machine operates as a standalone computing device or may be connected (e.g., networked) to other machines. If in a network environment, the computing machine may operate in the capacity of a server or a client computing machine in server-client network environment, or as a peer machine in a peer-to-peer (or distributed) network environment. Examples of the computing machine may include a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated in FIG. 5, the term “machine” shall also be taken to include any collection of machines that individually or jointly execute a set (or multiple sets) of instructions to perform any one or more of the methodologies discussed herein.

The exemplary computer system 500 includes a processor 502, e.g., a central processing unit (CPU), a graphics processing unit (GPU) or both, a main memory 504, which may include read only memory (ROM), flash memory, dynamic random access memory (DRAM) such as synchronous DRAM (SDRAM) or Rambus DRAM (RDRAM), etc., and a static memory 506. The static memory can include a flash memory, static random access memory (SRAM), etc., which communicate with each other via a bus 508.

The computer system 500 may further include a video display unit 510, such as a liquid crystal display (LCD), plasma display device, a field emission device, an electroluminescent device or a cathode ray tube (CRT), just to name a few. The computer system 700 also includes an alphanumeric input device 512, such as a keyboard, a cursor control device 514 (e.g., a mouse), a disk drive unit 516, a signal generation device 520, which may include a speaker, and a network interface device 522.

The disk drive unit 516 includes a computer-readable medium 724 on which is stored one or more sets of instructions, such as software 526, embodying any one or more of the methodologies or functions described herein. The software 526 may also reside, completely or at least partially, within the main memory 504 and/or within the processor 502 during execution thereof by the computer system 500, the main memory 504 and the processor 502 also constituting computer-readable media. The software 526 may further be transmitted or received over a network 528 via the network interface device 522.

While the computer-readable medium 524 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, and optical and magnetic media.

Thus, the above described method and apparatus in accordance with the embodiments of the present invention provides a very effective method for recommending relevant products to a user. As can now be fully appreciated, the present invention facilitates recommending products to a user.

The invention can be implemented over any type of communications channel, such as the Internet, a local area network (LAN), a wide area network (WAN), direct computer connections, or the like, using any type of communication hardware and protocols. Any type of hardware or combination of hardware can be used for various clients and servers. Accordingly, the term “computer” as used herein, refers to any type of computing device or data terminal, such as a personal computer, a portable computer, a dumb terminal, a thin client, a hand held device or any combination of such devices. The various clients and servers can be a single computer at a single location or multiple computers at a single or multiple locations. For example, a server may be comprised of a plurality of redundant computers disposed in co-location facilities at various locations to facilitate scalability. Any appropriate server or client software can be used and any communication protocols can be used. Communication can be accomplished over electric cable, fiber optic cable, any other cable, or in a wireless manner using radio frequency, infrared, or other technologies. Any interface can be used for selecting products for purchase. The various information can be stored in any format and thus the term “database” as used herein refers to any collection of information such as a database file, a lookup table, or the like. While the content items of the embodiment are catalog items. The invention can be applied to any type of content organized in a hierarchy. For example, the invention can be applied to various content items in a content management system such as audio content, video content, or textual content. The content can be downloaded or streamed.

The various functions can be implemented by modules which are computer hardware programmed in a desired manner through instructions stored on tangible computer readable media.

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A method for modifying a page stored in computer memory as multiple page elements, the method comprising:
receiving a request from a user for a page stored in a computer memory;
in response to the request, applying a set of rules to page elements of the page;
modifying the code corresponding to the page elements based on the rules; and
serving the page with the modified code to the user.

2. The method of claim 1, wherein said modifying step comprises making links in the page correspond to a standard ontology.

3. The method of claim 1, wherein said modifying step comprises making links in the page correspond to a branded user experience.

4. The method of claim 1, wherein said modifying step comprises making page elements correspond to resources of a user device.

5. The method of claim 1, wherein said modifying step comprises making links in the page correspond to content for which a user has subscribed.

6. A system for modifying a page stored in computer memory as multiple page elements comprising:
receiving a request from a user for a page stored in a computer memory;
a rules store for applying a set of rules to page elements of the page in response to the request;
a modification module for modifying the code corresponding to the page elements based on the rules; and
a web layer for serving the page with the modified code to the user.

7. The system of claim 6, wherein said modification module comprises making links in the page correspond to a standard ontology.

8. The system of claim 6, wherein said modifying step makes links in the page correspond to a branded user experience.

9. The system of claim 6, wherein said modification module makes page elements correspond to resources of a user device.

10. The system of claim 6, wherein said modification module makes links in the page correspond to content for which a user has subscribed.

11. A computer-readable storage media having computer executable instructions stored thereon which cause a computer system to carry out a method when executed, the method comprising:
receiving a request from a user for a page stored in a computer memory;
in response to the request, applying a set of rules to page elements of the page;
modifying the code corresponding to the page elements based on the rules; and
serving the page with the modified code to the user.

12. The computer-readable medium of claim 11, wherein said modifying step comprises making links in the page correspond to a standard ontology.

13. The computer-readable medium of claim 11, wherein said modifying step comprises making links in the page correspond to a branded user experience.

14. The computer-readable medium of claim 11, wherein said modifying step comprises making page elements correspond to resources of a user device.

15. The computer-readable medium of claim 11, wherein said modifying step comprises making links in the page correspond to content for which a user has subscribed.
